(19) United States
(12) Patent Application Publication
(10) Pub. No.: US 2014/0198912 A1
(43) Pub. Date: Jul. 17, 2014

(54) Block Cipher Modes of Non-Malleable Operation

(71) Applicant: Itsik Mantin, Shoham (IL)

(72) Inventor: Itsik Mantin, Shoham (IL)

(73) Assignee: Cisco Technology Inc., San Jose, CA (US)

(21) Appl. No.: 14/239,215

(22) PCT Filed: Jul. 24, 2012
(86) PCT No.: PCT/IB2012/053750

§ 371 Date: Feb. 18, 2014

(30) Foreign Application Priority Data
Aug. 18, 2011 (IL) 214743

(51) Int. Cl. H04L 9/06; H04L 9/14

(52) U.S. Cl. CPC H04L 9/0618; H04L 9/14
USPC 380/28

(57) ABSTRACT

A method and system for producing at least one ciphertext block from at least one plaintext block using a block cipher is described, the block cipher including an encryption function Enc, the method and system including receiving n plaintext blocks, wherein n is an integer greater than 0, for each plaintext block of the n plaintext blocks inputting two inputs into a keyed invertible transformation function, e, the two inputs including a masking value, denoted Mᵢ, where 0<i<=n, and one of a plaintext block, denoted Pᵢ, Pᵢ being an i-th plaintext block of the n plaintext blocks, and a function of the plaintext block Pᵢ, where 0<i<=n, wherein one of the two inputs Mᵢ and Pᵢ includes a key for round key generation by the function e and the second of the two inputs Mᵢ and Pᵢ includes a data item operated on during rounds of function e, outputting a result of the function e, the output being at least partially encrypted in a case where the masking value includes an output of the encryption function Enc, the output of the function e includes a ciphertext block, thereby producing n ciphertext blocks, in a case where the masking value includes one of one of Pᵢ_{^{−}}, and an initialization vector when i=1, and one of a function of Pᵢ₋₁, and an initialization vector when i=1, the output of the function e includes an input into the encryption function Enc, and the output of the function Enc includes a ciphertext block, thereby producing n ciphertext blocks, and in a case where the masking value includes one of an output of the function e(Mᵢ₋₁, Pᵢ₋₁), and an initialization vector when i=1, the input into the function Enc includes a result of xor-ing the masking value Mᵢ with Pᵢ, and the output of the function Enc includes a ciphertext block, thereby producing n ciphertext blocks. Related methods and systems are also described.

### FIELD OF THE INVENTION

Embodiments of the present invention described herein relate to cryptography, and more specifically, to block cipher cryptography.

### BACKGROUND OF THE INVENTION

Reference is now made to FIG. 1, which is a simplified block diagram illustration of a generalized block cipher (prior art). Block ciphers are well known in the art. Block ciphers typically encrypt plaintext in fixed sized n-bit blocks (often 16 or 64 bits, depicted as 16 bits). Block ciphers typically take an n-bit block of plain text and an n-bit key, and combine the block of plain text and the key using an encryption function, in order to output an n-bit block of cipher text.

For messages exceeding n bits, the simplest approach is to partition the message into n-bit blocks and encrypt each block separately. This mode of operation is usually referred to as “electronic-cookbook” (ECB) mode. There are other known modes of operation which attempt to solve various drawbacks of ECB. Well known modes of operation include CBC (Cipher Block Chaining), CFB (Cipher Feedback), and OFB (Output Feedback).

Various modes of operation are described in the Handbook of Applied Cryptography, by A. Menezes, P. van Oorschot and S. Vanstone, CRC Press, 1996. The Handbook of Applied Cryptography is also available on-line at www.cacr.math.uwterloo.ca/hac. See pages 228-233, 272, 367-368, and 645-654, which describe various well known and standard applications of modes of operation of block ciphers.

Malleability in cryptography is discussed at en.wikipedia.org/wiki/Malleability_%28cryptography %29.

Naor et-al analyze different ways to achieve non-malleability in cryptographic primitives in a paper “Non-Malleable Cryptography” available at www.wisdom.weizmann.ac.il/˜naor/PAPERS/nmc.ps.

Malleability in cryptography (see, for instance, en.wikipedia.org/wiki/Malleability_(cryptography)) is a property in which it is possible for an attacker to transform a cipher text into another cipher text in a manner that the new ciphertext will be decrypted by the legitimate decryptor into a plaintext that is related to the original plaintext in a way that is beneficial to the attacker. Naor et-al analyze different ways to achieve non-malleability in cryptographic primitives in “Non-Malleable Cryptography” (www.wisdom.weizmann.ac.il/˜naor/PAPERS/nmc.ps). However, they do not discuss solutions to the practical problem of non-malleable mode of operation for block ciphers. Those that are skilled in the art will appreciate that malleability attacks may be applicable in applications where the decryption process is subject to white-box cryptanalysis and graybox cryptanalysis, e.g., DRM applications.

Accordingly, it is desirable to use a block cipher mode of operation that has the following properties:
Provides immunity against controlled manipulation of plaintext data;
Allows parallel decryption of blocks in the client;
Has minimal performance overhead when compared to CBC; and
Leaves obscurity hooks, i.e., has “holes” in which different proprietary functions can be added.

The only block cipher mode of operation with which the inventors are familiar, which is immune against controlled manipulation of plaintext data are authenticated encryption schemes such as OCB, CCM, CWC, EAX, GCM, PCFB and XCBC. However, these usually prevent parallel decryption of the blocks and random access to the encrypted data which is a critical feature in many applications.

The description of the embodiments of the present invention herein provides a hypothetical example of several modes of operation that are based on using a mini-encryption function, which will typically be denoted herein as e. These include ePBC, xePBC, CS-PBC, and eCTR.

Published PCT application 2006/117775 of NDS Ltd. and corresponding granted U.S. Pat. No. 7,940,930 of Shen-Orr et al. describes a system for scrambling/descrambling packets of a stream of content, each packet having a must stay clear (MSC) section, the system including an input handler including a receiving module to receive the stream, a characteristic analyzer to analyze the stream in order to determine a data independent characteristic of each packet, and a scrambling/descrambling device operationally associated with the input handler, the scrambling/descrambling device including a receiving module to receive the data independent characteristic for each packet from the input handler, and an Initial Value module to determine an Initial Value for each packet as a function of the data independent characteristic of one of the packets being processed, wherein the scrambling/descrambling device is adapted to scramble and/or descramble the packets based on the Initial Value and a Control Word.

### SUMMARY OF THE INVENTION

The present invention, in certain embodiments thereof, seeks to provide an improved method of using block cipher encryption which is not susceptible to malleability attacks.

There is thus provided in accordance with another embodiment of the present invention method for producing at least one ciphertext block from at least one plaintext block using a block cipher, the block cipher comprising an encryption function Enc, the method including receiving n plaintext blocks, wherein n is an integer greater than 0, for each plaintext block of the n plaintext blocks inputting two inputs into a keyed invertible transformation function, e, the two inputs including a masking value, denoted Mᵢ, where 0<i<=n, and one of a plaintext block, denoted Pᵢ, Pᵢ being an i-th plaintext block of the n plaintext blocks, and a function of the plaintext block Pᵢ, where 0<i<=n, wherein one of the two inputs Mᵢ and Pᵢ includes a key for round key generation by the function e and the second of the two inputs Mᵢ and Pᵢ includes a data item operated on during rounds of function e, outputting a result of the function e, the output being at least partially encrypted in a case where the masking value includes an output of the encryption function Enc, the output of the function e includes a ciphertext block, thereby producing n ciphertext blocks, in a case where the masking value includes one of one of Pᵢ₋₁, and an initialization vector when i=1, and one of a function of Pᵢ₋₁, and an initialization vector when i=1, the output of the function e includes an input into the encryption function Enc, and the output of the function Enc includes a ciphertext block, thereby producing n ciphertext blocks, and in a case where the masking value includes one of an output of the function e(Mᵢ₋₁, Pᵢ₋₁), and an initialization vector when i=1, the input into the function Enc includes a result of xor-ing the masking value Mᵢ with Pᵢ, and the output of the function Enc includes a ciphertext block, thereby producing n ciphertext blocks.

There is further provided in accordance with another embodiment of the present invention a method for producing at least one ciphertext block from at least one plaintext block using a block cipher, the block cipher comprising an encryption function Enc, the method including receiving n plaintext blocks, wherein n is an integer greater than 0, for each plaintext block of the n plaintext blocks computing an output of a function e, the output being e(Mᵢ, Pᵢ), and computing Enc(e(Mᵢ, Pᵢ)) according to a key of the block cipher, thereby producing n ciphertext blocks, wherein function e includes a keyed invertible transformation function, 0<i<=n, Pᵢ denotes an i-th plaintext block of the n plaintext blocks, and Mᵢ denotes a masking value, the masking value being Pᵢ₋₁ for i>1, and an initialization vector for i=1.

Further in accordance with an embodiment of the present invention function e includes a plurality of rounds of a second block cipher encryption or decryption function.

Still further in accordance with an embodiment of the present invention function e includes 3 rounds of the second block cipher encryption function.

Additionally in accordance with an embodiment of the present invention a round key generation algorithm of function e includes one of the round key generation algorithm of the second block cipher encryption function, and an non-standard derivation algorithm.

Moreover in accordance with an embodiment of the present invention the non-standard derivation algorithm includes xor-ing a key with round constants.

Further in accordance with an embodiment of the present invention the round function of function e includes one of the round key generation algorithm of the second block cipher encryption function, and a tweaked block cipher round function.

Still further in accordance with an embodiment of the present invention the tweaked block cipher round function includes any of pseudo-random tables, pseudo-random s-boxes, and pseudo-random p-boxes.

There is also provided in accordance with still another embodiment of the present invention a method for producing at least one plaintext block from at least one ciphertext block using a block cipher, the block cipher including and decryption function Dec, the method including receiving n ciphertext blocks, wherein n is an integer greater than 0, for each ciphertext block of the n ciphertext blocks computing an output of the function Dec, the output being Dec(Cᵢ), according to a key of the block cipher, and computing e⁻¹(Mᵢ,Dec(Cᵢ)), thereby producing n plaintext blocks, wherein function e⁻¹ includes a keyed invertible transformation function, 0<i<=n, Cᵢ denotes an i-th ciphertext block of the n ciphertext blocks, and Mᵢ denotes a masking value, the masking value being Pᵢ₋₁ for i>1, and an initialization vector for M₁, and Pᵢ denoting an i-th plaintext block of the n plaintext blocks.

Further in accordance with an embodiment of the present invention function e⁻¹ includes a plurality of rounds of a second block cipher encryption function.

Still further in accordance with an embodiment of the present invention function e⁻¹ includes 3 rounds of a second block cipher encryption function.

Additionally in accordance with an embodiment of the present invention a round key generation algorithm of function e⁻¹ includes one of the round key generation algorithm of the second block cipher encryption function, and an non-standard derivation algorithm.

Moreover in accordance with an embodiment of the present invention the non-standard derivation algorithm includes xor-ing a key with round constants.

Further in accordance with an embodiment of the present invention the round function of function e⁻¹ includes one of the round key generation algorithm of the second block cipher encryption function, and a tweaked block cipher round function.

Still further in accordance with an embodiment of the present invention the tweaked block cipher round function includes any of pseudo-random tables, pseudo-random s-boxes, and pseudo-random p-boxes.

Additionally in accordance with an embodiment of the present invention the function e⁻¹ includes the inverse of function e.

There is also provided in accordance with still another embodiment of the present invention a method for producing at least one ciphertext block from at least one plaintext block using a block cipher, the block cipher including and encryption function Enc, the method including receiving n plaintext blocks, wherein n is an integer greater than 0, for each plaintext block of the n plaintext blocks computing an output of a function e, the output being e(Mᵢ, Pᵢ), and computing Enc(Pᵢ⊕Mᵢ) according to a key of the block cipher, thereby producing n ciphertext blocks, wherein function e includes a keyed invertible transformation function, 0<i<=n, Pᵢ denotes an i-th plaintext block of the n plaintext blocks, and Mᵢ denotes a masking value, the masking value being e(Mᵢ₋₁, Pᵢ₋₁) for i>1, and an initialization vector for i=1.

Further in accordance with an embodiment of the present invention function e includes a plurality of rounds of a second block cipher encryption function.

Still further in accordance with an embodiment of the present invention function e includes 3 rounds of the second block cipher encryption function.

Additionally in accordance with an embodiment of the present invention wherein a round key generation algorithm of function e includes one of the round key generation algorithm of the second block cipher encryption function, and an non-standard derivation algorithm.

Moreover in accordance with an embodiment of the present invention the non-standard derivation algorithm includes xor-ing a key with round constants.

Further in accordance with an embodiment of the present invention the round function of function e includes one of the round key generation algorithm of the second block cipher encryption function, and a tweaked block cipher round function.

Still further in accordance with an embodiment of the present invention the tweaked block cipher round function includes any of pseudo-random tables, pseudo-random s-boxes, and pseudo-random p-boxes.

There is also provided in accordance with another embodiment of the present invention a method for producing at least one plaintext block from at least one ciphertext block using a block cipher, the block cipher including and decryption function Dec, the method including receiving n ciphertext blocks, wherein n is an integer greater than 0, for each ciphertext block of the n ciphertext blocks computing (Mᵢ⊕Dec(Cᵢ)) according to a key of the block cipher, thereby producing n plaintext blocks, wherein function e includes a keyed invertible transformation function, 0<i<=n, Cᵢ denotes an i-th ciphertext block of the n ciphertext blocks, and Mᵢ denotes a masking value, the masking value being e(Pᵢ₋₁, Mᵢ₋₁) for i>1, and an initialization vector for i=1, Pᵢ denoting an i-th plaintext block of the n plaintext blocks.

Further in accordance with an embodiment of the present invention function e includes a plurality of rounds of a second block cipher encryption function.

Still further in accordance with an embodiment of the present invention function e includes 3 rounds of the second block cipher encryption function.

Additionally in accordance with an embodiment of the present invention a round key generation algorithm of function e includes one of the round key generation algorithm of the second block cipher encryption function, and an non-standard derivation algorithm.

Moreover in accordance with an embodiment of the present invention the non-standard derivation algorithm includes xor-ing a key with round constants.

Further in accordance with an embodiment of the present invention the round function of function e includes one of the round key generation algorithm of the second block cipher encryption function, and a tweaked block cipher round function.

Still further in accordance with an embodiment of the present invention the tweaked block cipher round function includes any of pseudo-random tables, pseudo-random s-boxes, and pseudo-random p-boxes.

There is also provided in accordance with still another embodiment of the present invention a method for producing at least one ciphertext block from at least one plaintext block using a block cipher, the block cipher including and encryption function Enc, the method including receiving n plaintext blocks, wherein n is an integer greater than 0, for each plaintext block of the n plaintext blocks computing an output of a function e, the output being e(Mᵢ, Pᵢ), and computing Enc(e(Mᵢ, Pᵢ)) according to a key of the block cipher, thereby producing n ciphertext blocks, wherein function e includes a keyed invertible transformation function, 0<i<=n, Pᵢ denotes an i-th plaintext block of the n plaintext blocks, and Mᵢ denotes a masking value, the masking value being xTend(CS(Pᵢ₋₁)) for i>1, and an initialization vector for i=1, where CS denotes a shrinking function, and xTend denotes a function which extends an output of the CS function into a value of an original block length.

Further in accordance with an embodiment of the present invention the shrinking function includes a checksum function.

Still further in accordance with an embodiment of the present invention the shrinking function outputs an output of 1-3 bytes long.

Additionally in accordance with an embodiment of the present invention the xTend function extends the output of the CS function with a fixed vector.

Moreover in accordance with an embodiment of the present invention the xTend function extends the output of the CS function by repeating the output of the CS function in order to extend the output to a fixed length.

Further in accordance with an embodiment of the present invention the xTend function includes a lookup table, and the output of the CS function includes an index of the lookup table.

Still further in accordance with an embodiment of the present invention function e includes a plurality of rounds of a second block cipher encryption function.

Additionally in accordance with an embodiment of the present invention function e includes 3 rounds of the second block cipher encryption function.

Moreover in accordance with an embodiment of the present invention a round key generation algorithm of function e includes one of the round key generation algorithm of the second block cipher encryption function, and an non-standard derivation algorithm.

Further in accordance with an embodiment of the present invention the non-standard derivation algorithm includes xor-ing a key with round constants.

Still further in accordance with an embodiment of the present invention the round function of function e includes one of the round key generation algorithm of the second block cipher encryption function, and a tweaked block cipher round function.

Additionally in accordance with an embodiment of the present invention the tweaked block cipher round function includes any of pseudo-random tables, pseudo-random s-boxes, and pseudo-random p-boxes.

There is also provided in accordance with still another embodiment of the present invention a method for producing at least one plaintext block from at least one ciphertext block using a block cipher, the block cipher including and decryption function Dec, the method including receiving n ciphertext blocks, wherein n is an integer greater than 0, for each ciphertext block of the n ciphertext blocks computing an output of the function Dec, the output being Dec(Cᵢ), according to a key of the block cipher, computing e⁻¹(Mᵢ, Dec(Cᵢ)), thereby producing n plaintext blocks, wherein function e⁻¹ includes a keyed invertible transformation function, 0<i<=n, Cᵢ denotes an i-th ciphertext block of the n ciphertext blocks, and Mᵢ denotes a masking value, the masking value being xTend(CS(Pᵢ₋₁)) for i>1, and an initialization vector for i=1, where CS denotes a shrinking function, and xTend denotes a function which extends an output of the CS function into a value of an original block length.

Further in accordance with an embodiment of the present invention the shrinking function includes a checksum function.

Still further in accordance with an embodiment of the present invention the shrinking function outputs an output of 1-3 bytes long.

Additionally in accordance with an embodiment of the present invention the xTend function extends the output of the CS function with a fixed vector.

Moreover in accordance with an embodiment of the present invention the xTend function extends the output of the CS function by repeating the output of the CS function in order to extend the output to a fixed length.

Further in accordance with an embodiment of the present invention the xTend function includes a lookup table, and the output of the CS function includes an index of the lookup table.

Still further in accordance with an embodiment of the present invention function e⁻¹ includes a plurality of rounds of a second block cipher encryption function.

Additionally in accordance with an embodiment of the present invention function e⁻¹ includes 3 rounds of the second block cipher encryption function.

Moreover in accordance with an embodiment of the present invention a round key generation algorithm of function e⁻¹ includes one of the round key generation algorithm of the second block cipher encryption function, and a non-standard derivation algorithm.

Further in accordance with an embodiment of the present invention non-standard derivation algorithm includes xor-ing a key with round constants.

Still further in accordance with an embodiment of the present invention the round function of function e⁻¹ includes one of the round key generation algorithm of the second block cipher encryption function, and a tweaked block cipher round function.

Additionally in accordance with an embodiment of the present invention the tweaked block cipher round function includes any of pseudo-random tables, pseudo-random s-boxes, and pseudo-random p-boxes.

Moreover in accordance with an embodiment of the present invention the function e⁻¹ includes the inverse of function e.

There is also provided in accordance with still another embodiment of the present invention a method for producing at least one ciphertext block from at least one plaintext block using a block cipher, the block cipher including and encryption function Enc, the method including receiving n plaintext blocks, wherein n is an integer greater than 0, for each plaintext block of the n plaintext blocks computing Mᵢ=Enc(IVᵢ) according to a key of the block cipher, and computing e(Mᵢ, Pᵢ) thereby producing n ciphertext blocks, wherein function e includes a keyed invertible transformation function, 0<i<=n, Pᵢ denotes an i-th plaintext block of the n plaintext blocks, IVᵢ denotes an initialization vector, and Mᵢ denotes a masking value.

Further in accordance with an embodiment of the present invention function e includes a plurality of rounds of a second block cipher encryption function.

Still further in accordance with an embodiment of the present invention function e includes 3 rounds of the second block cipher encryption function.

Additionally in accordance with an embodiment of the present invention a round key generation algorithm of function e includes one of the round key generation algorithm of the second block cipher encryption function, and an non-standard derivation algorithm.

Moreover in accordance with an embodiment of the present invention the non-standard derivation algorithm includes xor-ing a key with round constants.

Further in accordance with an embodiment of the present invention the round function of function e includes one of the round key generation algorithm of the second block cipher encryption function, and a tweaked block cipher round function.

Still further in accordance with an embodiment of the present invention the tweaked block cipher round function includes any of pseudo-random tables, pseudo-random s-boxes, and pseudo-random p-boxes.

Additionally in accordance with an embodiment of the present invention IVᵢ=IV+i−1.

There is also provided in accordance with still another embodiment of the present invention a method for producing at least one plaintext block from at least one ciphertext block using a block cipher, the block cipher including and encryption function Enc, the method including receiving n ciphertext blocks, wherein n is an integer greater than 0, for each ciphertext block of the n ciphertext blocks computing Mᵢ=Enc(IVᵢ) according to a key of the block cipher, computing e⁻¹ (Mᵢ, Cᵢ) thereby producing n plaintext blocks, wherein function e⁻¹ includes a plurality of rounds of a keyed invertible transformation function, 0<i<=n, Cᵢ denotes an i-th ciphertext block of the n ciphertext blocks, IVᵢ denotes an initialization vector, and Mᵢ denotes a masking value.

Further in accordance with an embodiment of the present invention function e⁻¹ includes a plurality of rounds of a second block cipher encryption function.

Still further in accordance with an embodiment of the present invention function e⁻¹ includes 3 rounds of the second block cipher encryption function.

Additionally in accordance with an embodiment of the present invention a round key generation algorithm of function e⁻¹ includes one of the round key generation algorithm of the second block cipher encryption function, and an non-standard derivation algorithm.

Moreover in accordance with an embodiment of the present invention the non-standard derivation algorithm includes xor-ing a key with round constants.

Further in accordance with an embodiment of the present invention the round function of function e⁻¹ includes one of the round key generation algorithm of the second block cipher encryption function, and a tweaked block cipher round function.

Still further in accordance with an embodiment of the present invention the tweaked block cipher round function includes any of pseudo-random tables, pseudo-random s-boxes, and pseudo-random p-boxes.

Additionally in accordance with an embodiment of the present invention IVᵢ=IV+i−1.

Moreover in accordance with an embodiment of the present invention the function e⁻¹ includes the inverse of function.

There is also provided in accordance with still another embodiment of the present invention an apparatus for producing at least one ciphertext block from at least one plaintext block using a block cipher, the block cipher including an encryption function Enc, the apparatus including a receiving unit for receiving n plaintext blocks, wherein n is an integer greater than 0, an initialization unit operative to set an initialization vector equal to an initial value, a computation unit operative, for each plaintext block of the n plaintext blocks to compute an output of a function e, the output being e(Mᵢ, Pᵢ), and to compute Enc(e(Mᵢ, Pᵢ)) according to a key of the block cipher, thereby producing n ciphertext blocks, wherein function e includes a keyed invertible transformation function, 0<i<=n, Pᵢ denotes an i-th plaintext block of the n plaintext blocks, and Mᵢ denotes a masking value, the masking value being Pᵢ₋₁ for i>1, and the initialization vector for i=1.

There is also provided in accordance with still another embodiment of the present invention an apparatus for producing at least one plaintext block from at least one ciphertext block using a block cipher, the block cipher including and decryption function Dec, the apparatus including a receiving unit for receiving n plaintext blocks, wherein n is an integer greater than 0, an initialization unit operative to set an initialization vector equal to an initial value, a computation unit operative, for each plaintext block of the n plaintext blocks to compute an output of the function Dec, the output being Dec(Cᵢ), according to a key of the block cipher, and to compute e⁻¹(Mᵢ,Dec(Cᵢ)), thereby producing n plaintext blocks, wherein function e⁻¹ includes a keyed invertible transformation function, 0<i<=n, Cᵢ denotes an i-th ciphertext block of the n ciphertext blocks, and Mᵢ denotes a masking value, the masking value being for Pᵢ₋₁ for i>1, and the initialization vector for M₁, and Pᵢ denoting an i-th plaintext block of the n plaintext blocks.

There is also provided in accordance with still another embodiment of the present invention an apparatus for producing at least one ciphertext block from at least one plaintext block using a block cipher, the block cipher including and encryption function Enc, the apparatus including a receiving unit for receiving n plaintext blocks, wherein n is an integer greater than 0, an initialization unit operative to set an initialization vector equal to an initial value, a computation unit operative, for each plaintext block of the n plaintext blocks to compute an output of a function e, the output being e(Mᵢ, Pᵢ), and to compute Enc(Pᵢ⊕Mᵢ) according to a key of the block cipher, thereby producing n ciphertext blocks, wherein function e includes a keyed invertible transformation function, 0≦i<=n, Pᵢ denotes an i-th plaintext block of the n plaintext blocks, and Mᵢ denotes a masking value, the masking value being Pᵢ₋₁) for i>1, and the initialization vector for i=1.

There is also provided in accordance with still another embodiment of the present invention an apparatus for producing at least one plaintext block from at least one ciphertext block using a block cipher, the block cipher including and decryption function Dec, the apparatus including a receiving unit for receiving n ciphertext blocks, wherein n is an integer greater than 0, an initialization unit operative to set an initialization vector equal to an initial value, a computation unit operative, for each ciphertext block of the n ciphertext blocks to compute (Mᵢ⊕Dec(Cᵢ)) according to a key of the block cipher, thereby producing n plaintext blocks, wherein function e includes a keyed invertible transformation function, 0≦i<=n, Cᵢ denotes an i-th ciphertext block of the n ciphertext blocks, and Mᵢ denotes a masking value, the masking value being e(Pᵢ₋₁, Mᵢ₋₁) for i>1, and the initialization vector for i=1, Pᵢ denoting an i-th plaintext block of the n plaintext blocks.

There is also provided in accordance with still another embodiment of the present invention an apparatus for producing at least one ciphertext block from at least one plaintext block using a block cipher, the block cipher including and encryption function Enc, the apparatus including a receiving unit for receiving n plaintext blocks, wherein n is an integer greater than 0, an initialization unit operative to set an initialization vector equal to an initial value, a computation unit operative, for each plaintext block of the n plaintext blocks to compute an output of a function e, the output being e(Mᵢ, Pᵢ), and to compute Enc(e(Mᵢ, Pᵢ)) according to a key of the block cipher, thereby producing n ciphertext blocks, wherein function e includes a keyed invertible transformation function, 0<i<=n, Pᵢ denotes an i-th plaintext block of the n plaintext blocks, and Mᵢ denotes a masking value, the masking value being xTend(CS(Pᵢ₋₁)) for i>1, and the initialization vector for i=1, where CS denotes a shrinking function, and xTend denotes a function which extends an output of the CS function into a value of an original block length.

There is also provided in accordance with still another embodiment of the present invention an apparatus for producing at least one plaintext block from at least one ciphertext block using a block cipher, the block cipher including and decryption function Dec, the apparatus including a receiving unit for receiving n ciphertext blocks, wherein n is an integer greater than 0, an initialization unit operative to set an initialization vector equal to an initial value, a computation unit operative, for each ciphertext block of the n ciphertext blocks to compute an output of the function Dec, the output being Dec(Cᵢ), according to a key of the block cipher, to compute e⁻¹(Mᵢ, Dec(Cᵢ)), thereby producing n plaintext blocks, wherein function e⁻¹ includes a keyed invertible transformation function, 0<i<=n, Cᵢ denotes an i-th ciphertext block of the n ciphertext blocks, and Mᵢ denotes a masking value, the masking value being xTend(CS(Pᵢ₋₁)) for i>1, and the initialization vector for i=1, where CS denotes a shrinking function, and xTend denotes a function which extends an output of the CS function into a value of an original block length.

There is also provided in accordance with still another embodiment of the present invention an apparatus for producing at least one ciphertext block from at least one plaintext block using a block cipher, the block cipher including and encryption function Enc, the apparatus including a receiving unit for receiving n plaintext blocks, wherein n is an integer greater than 0, an initialization unit operative to set an initialization vector equal to an initial value, a computation unit operative, for each plaintext block of the n plaintext blocks to compute Mᵢ=Enc(IVᵢ) according to a key of the block cipher, and to compute e(Mᵢ, Pᵢ), thereby producing n ciphertext blocks, wherein function e includes a keyed invertible transformation function, 0<i<=n, Pᵢ denotes an i-th plaintext block of the n plaintext blocks, IVᵢ denotes an initialization vector, and Mᵢ denotes a masking value.

There is also provided in accordance with still another embodiment of the present invention an apparatus for producing at least one plaintext block from at least one ciphertext block using a block cipher, the block cipher including and encryption function Enc, the apparatus including a receiving unit for receiving n plaintext blocks, wherein n is an integer greater than 0, an initialization unit operative to set an initialization vector equal to an initial value, a computation unit operative, for each ciphertext block of the n ciphertext blocks to compute Mᵢ=Enc(IVᵢ) according to a key of the block cipher, to compute e⁻¹(Mᵢ, Cᵢ) thereby producing n plaintext blocks, wherein function e⁻¹ includes a plurality of rounds of a keyed invertible transformation function, 0<i<=n, Cᵢ denotes an i-th ciphertext block of the n ciphertext blocks, IVᵢ denotes the initialization vector, and Mᵢ denotes a masking value.

### BRIEF DESCRIPTION OF THE DRAWINGS

Embodiments of the present invention will be understood and appreciated more fully from the following detailed description, taken in conjunction with the drawings in which:

FIG. 1 is a simplified block diagram illustration of a generalized block cipher (prior art);

FIG. 2 is a simplified block diagram illustration of a block cipher usage implementing an ePBC mode of operation, constructed and operative in accordance with an embodiment of the present invention;

FIG. 3 is a simplified block diagram illustration of a block cipher usage implementing an xePBC mode of operation, constructed and operative in accordance with an embodiment of the present invention;

FIG. 4 is a simplified block diagram illustration of a block cipher usage implementing an CS-ePBC mode of operation, constructed and operative in accordance with an embodiment of the present invention;

FIG. 5 is a simplified block diagram illustration of a block cipher usage implementing an eCTR mode of operation, constructed and operative in accordance with an embodiment of the present invention;

FIG. 6 is a simplified block diagram illustration of an implementation of function e of FIGS. 2-5; and

FIGS. 7-14 are simplified flowchart diagrams of preferred methods of operation of the systems described in FIGS. 2-5.

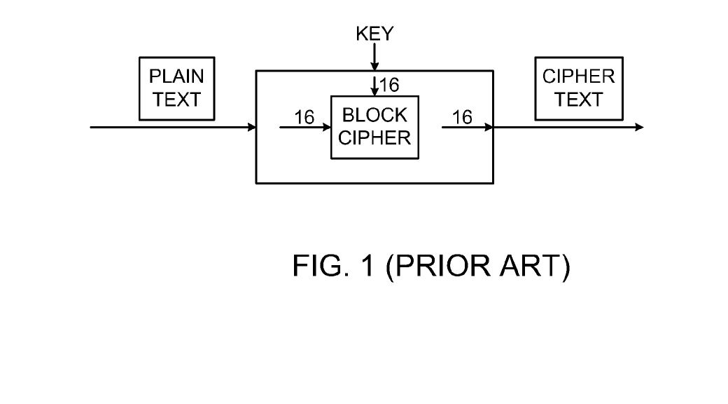

### DETAILED DESCRIPTION OF AN EMBODIMENT

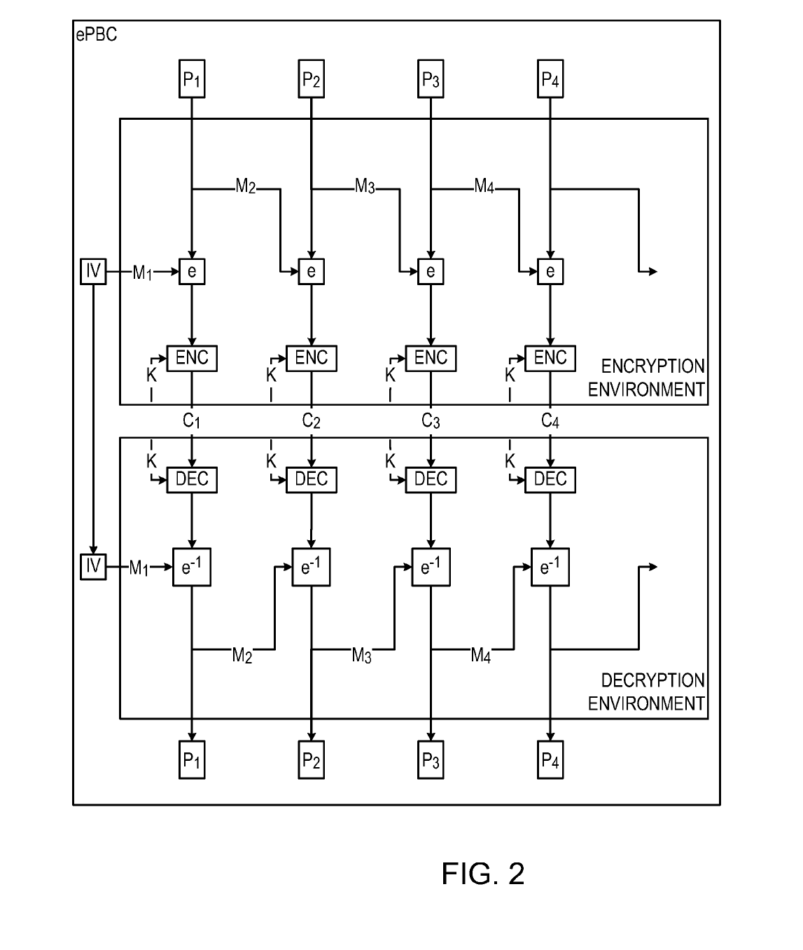

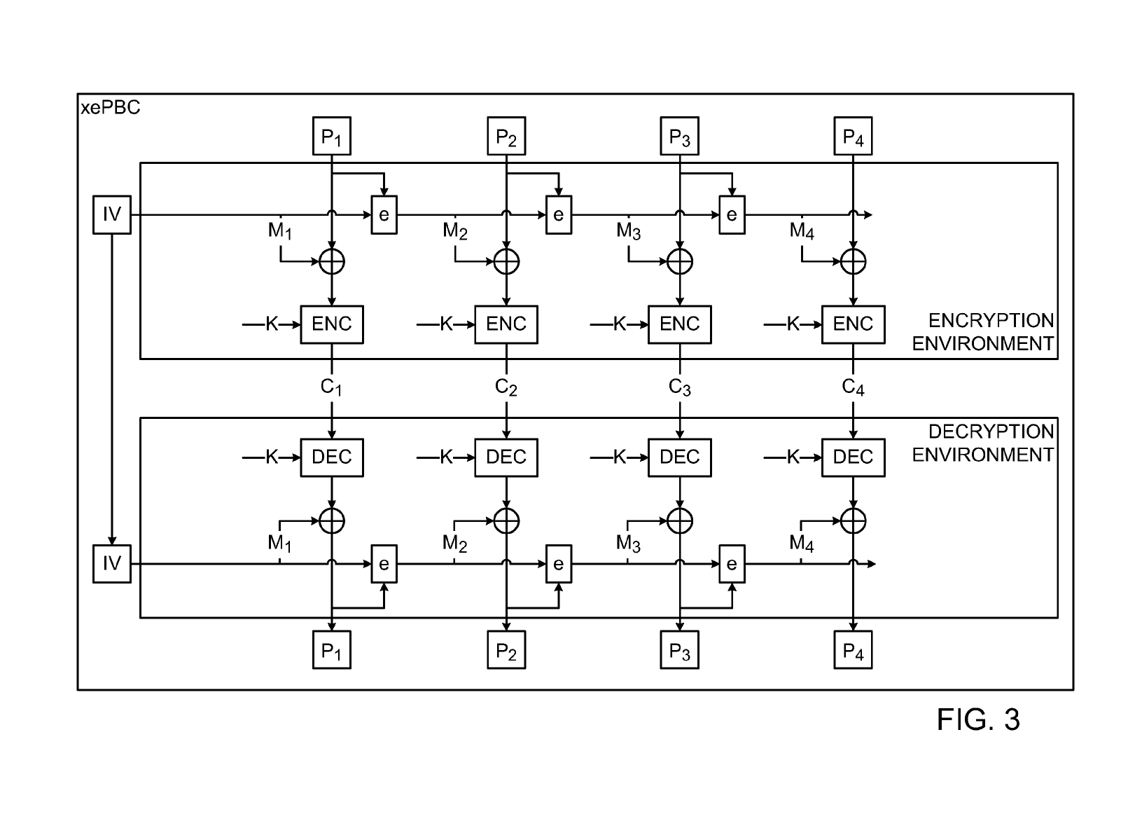

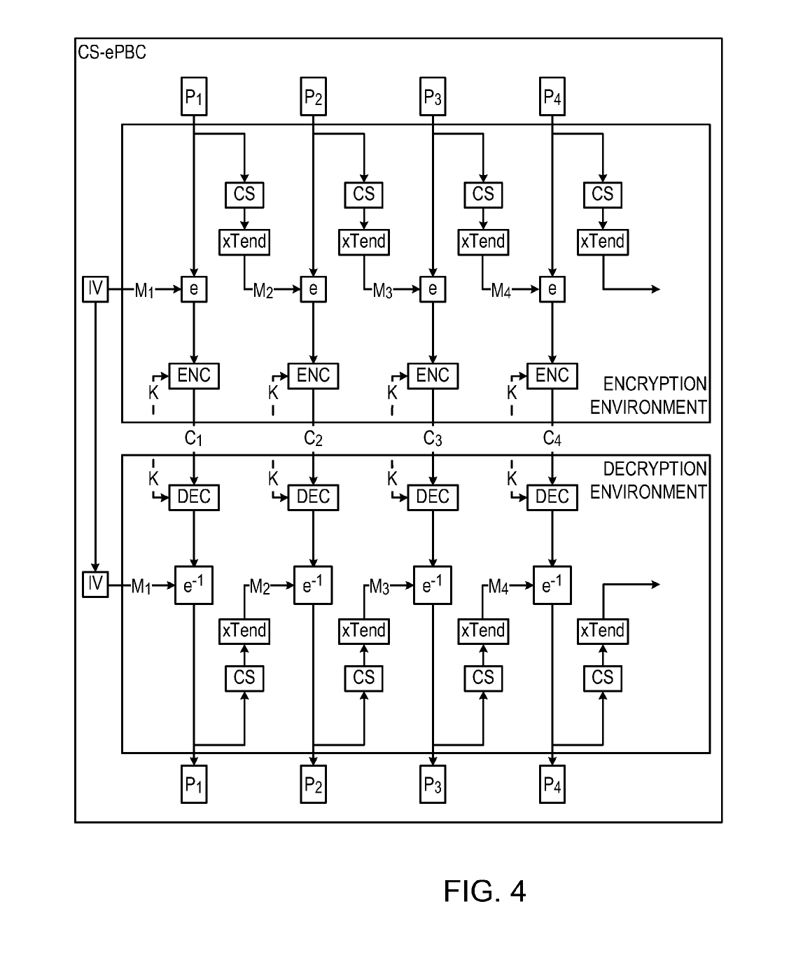

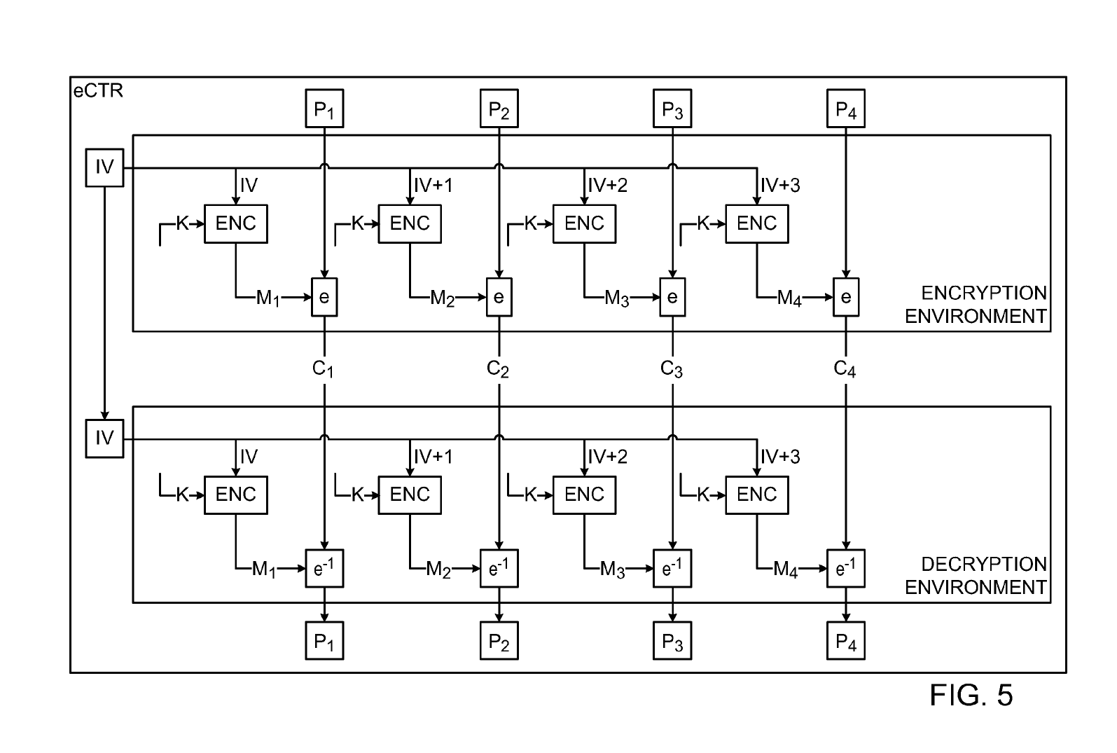

Reference is now made to FIGS. 2-5, which are simplified block diagram illustrations of various modes of operation for block ciphers, the block diagram illustrations being drawn in a form that will be understood by persons of skill in the art. Specifically, FIG. 2 is a block diagram illustration of a block cipher usage implementing an ePBC mode of operation, constructed and operative in accordance with an embodiment of the present invention. FIG. 3 is a simplified block diagram illustration of a block cipher usage implementing an xePBC mode of operation, constructed and operative in accordance with an embodiment of the present invention. FIG. 4 is a simplified block diagram illustration of a block cipher usage implementing an CS-ePBC mode of operation, constructed and operative in accordance with an embodiment of the present invention. FIG. 5 is a simplified block diagram illustration of a block cipher usage implementing an eCTR mode of operation, constructed and operative in accordance with an embodiment of the present invention.

As was noted above, each of the block ciphers described herein are implementing a mode of operation that is based on using a mini-encryption function, denoted e. As a non-limiting example, in FIG. 2, the block e receives plain text inputs and either a plain text input from a previous activation of the block cipher, or, in the first activation of the block cipher, an initialization vector.

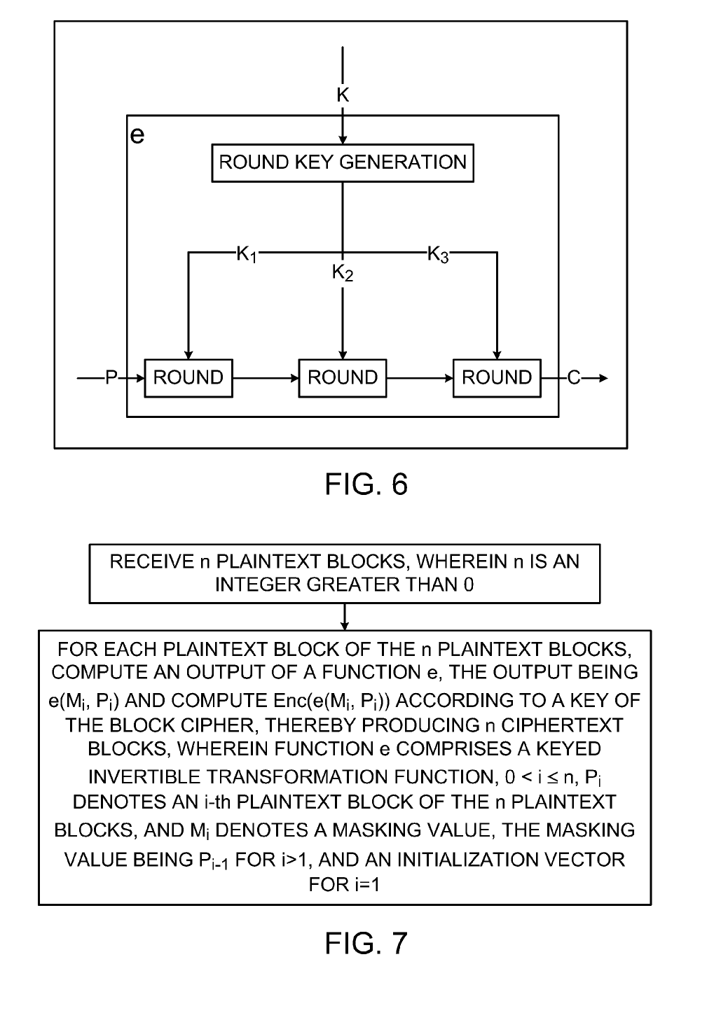

Turning to the implementation of the mode of operation described herein with reference to FIG. 2, the ePBC mode of operation is similar to the well known Plaintext-Block-Chaining (PBC) mode of operation. However, the exclusive-or (XOR) operation used in PBC is replaced with the function e. The implementation of the function e is discussed below with reference to FIG. 6.

With regard to FIGS. 2-5, those skilled in the art will appreciate that the discussion herein is symmetrical, with respect to encryption and decryption. Hence, although the present discussion focuses primarily on the use of the function e in the context of encryption, this is solely for the sake of ease of discussion, and in no way is meant to be limiting. Rather, the lack of discussion of decryption is due to the symmetric nature of encryption/decryption in block ciphers.

Turning to the implementation of the mode of operation described herein with reference to FIG. 3, the xePBC mode of operation is similar to the well known Plaintext-Block-Chaining (PBC) mode of operation. During encryption, the initialization vector (IV) and the plaintext blocks are used by the function e to generate a sequence of masking blocks M₁, M₂, M₃, . . . to be masked (XOR-ed) with the plaintext prior to encryption.

The masking block Mᵢ for plaintext block Pᵢ is a function of the IV and all precious plaintext blocks, P₁, . . . , Pᵢ₋₁.

Despite the dependency on previous blocks, the desired property of parallelized decryption is fulfilled because the main decryption operation, that is to say, the block decryption, can run in parallel for all blocks independently and only resolution of the masking values (i.e., the computationally lighter operation) should run sequentially.

Turning to the implementation of the mode of operation described herein with reference to FIG. 4, the CS-ePBC mode of operation comprises, in addition to the ePBC mode described above, a CS (checksum) module. The CS module shrinks the previous plaintext value (i.e. the chaining value) into a small size, for example and without limiting the generality of the foregoing, by performing a checksum operation on the previous plaintext value (for example a byte checksum or a CRC). (It is understood that the phrase, “a small size” refers to a size which is smaller than the size of the plaintext block.) Typically, the plaintext value is shrunk to a size that ranges between 1-3 bytes.

The xTend module extends the result of the CS module (the checksum) into a value of the original block length, for example and without limiting the generality of the foregoing, by circular usage of the checksum bytes to the required length, or by padding with a fixed vector. The xTend module might work in a fashion as is known in the art. For example and without limiting the generality of the foregoing, the xTend module may pad the output of the CS module with a fixed vector, such as adding 13 bytes of all zeros to a 3 byte shrunken plaintext.

Alternatively, the xTend module may repeat the output of the CS module to extend the value to the full length. For example and without limiting the generality of the foregoing, if the output of the CS module is 2 bytes in length, the xTend module may repeat those two bytes an additional seven times, in order to achieve a 16 byte block.

Alternatively, the xTend module may use the output of the CS module as an index for a lookup table (i.e. an S-box). So, an output of the CS module may comprise a 1-3 byte output, as was noted above. The result of the lookup is a 16 byte output which is input into the function e.

The rationale for using the CS and xTend modules is to facilitate random access in the decryption environment through trial and error of the shrunken chaining value. The number of potential chaining values (outputted from the xTend module) is thus 2^{L} (L being the checksum length) and for small enough L (e.g., 16 bits) the masking value can be found through trial and error of only 2^{L} trials (65536 in the example). The decryptor tries to calculate the plaintext message using each of the 2^{L} possible values of CS(Pᵢ₋₁) until the decryptor recognizes that the resultant Pᵢ is the correct Pᵢ.

Turning to the implementation of the mode of operation described herein with reference to FIG. 5, the eCTR mode of operation is similar to the well known Counter (CTR) mode of operation. In the eCTR mode of operation, the XOR function is replaced with the e function.

Reference is now made to FIG. 6, which is a simplified block diagram illustration of an implementation of function e of FIGS. 2-5. As was noted above, the function e is a mini-encryption function that breaks trivial patterns in the processed data but does not necessarily have cryptographic strength. The function e uses two inputs: a first input comprising a data item and a second input comprising a key.

The function e produces an output.

The function e is a keyed invertible transformation which means that for a fixed key k there is an inverse function e⁻¹ for which the following holds for every x: e⁻¹(k, e(k,x))=e(k, e⁻¹(k,x))=x.

The function e need not be a cryptographically secure function, but rather a ‘light’ scrambling function that breaks trivial patterns in the sequence of the masking values.

The function e can have various implementations. For example and without limiting the generality of the foregoing, a small number of rounds, say 3, of a block cipher, such as AES, DES, Serpent, Skipjack, with a simple round keys generation.

The round key generation algorithm can be either the ‘regular’ block cipher round key generation algorithm (that is to say the key expansion or key scheduling of the implemented block cipher), or a different trivial derivation algorithm, such as XOR-ing the key with round constants.

For example and without limiting the generality of the foregoing, one implementation of the round key generation algorithm for e that uses 3 rounds of a block cipher using 16-byte round keys might be:

RoundKeyGeneration(k):
K1←K⊕0x93FDDA10D3F8E4F0C5919ECBCA2BB073
K2←K⊕0x0E34C707BE75338BF13558EDD2B40293
K3←K⊕0x9F758C53D926BEF21FC90A83AC73E42B
Return K1, K2, K3.

The round function can be implemented as the round function of any known block cipher, as was noted above. The round function can be either the “regular” block cipher round function, or a tweaked block cipher round function.

For example, letting:
T0, T1, T2, T3 be fast AES tables (each including 256 4-byte values)

and letting:
P0, P1, P2, . . . , P15 be [0,5,10,15,4,9,14,3,8,13,2,7,12,1,6,11]

(the AES ShiftRows permutation), the AES round function looks as follows:

AesRound (S, RK):
For i in 0.4:
   S[0 . . . 3]=T0[S[P4*i]]⊕T1[S[P4*i+1]]⊕T2[S[P4*i+2]]⊕T3[S[P4*i+3]]
Return S

For example, letting:
T0, T1, T2, T3 be some pseudo random tables (each including 256 4-byte values)

and letting:
P0, P1, P2, . . . , P15 be some pseudo random permutation of 0 . . . 15

a tweaked AES round function will be:
AesTweakedRound (S, RK):
For i in 0.4:
   S[0 . . . 3]=T0[S[P4*i]]⊕T1[S[P4*i+1]]⊕T2[S[P4*i+2]]⊕T3[S[P4*i+3]]
Return S

Referring once again to FIG. 2:

For the encryption side, in every activation of the block cipher encryption function, the plaintext block is processed through the function e before being input into the block cipher encryption function. The function e uses the masking value as the key, the masking value being the previous plaintext block (or an initialization vector IV in the case of the first block).

For the decryption side, in every activation of the block cipher decryption function, the ciphertext block is decrypted in the block cipher and then is processed through the function e⁻¹ (the inverse of e), with the function e using the masking value as the key, the masking value being the previous plaintext block (or an initialization vector IV in the case of the first block). Those skilled in the art will appreciate that for the embodiments of e discussed above, e⁻¹, the inverse of e, is trivially derived.

Referring once again to FIG. 3:

For the encryption side, in each activation of the block cipher encryption function, the plaintext block is xor-ed with the masking value before being input into the block cipher encryption function. The masking value is also processed by the function e in order to produce the masking value for the next activation of the block cipher. The plaintext block is used as the key for the function e (or an initialization vector IV in the case of the first block) for the next activation of the block cipher.

For decryption side, in each activation of the block cipher decryption function, the ciphertext is decrypted in the block cipher and then is processed by being xor-ed with the masking value. The result of the xor-ing is the plaintext. The masking value is processed by the function e in order to produce the masking value for the next activation of the block cipher. The plaintext block (or an initialization vector IV in the case of the first block) is used as the key for the function e for the next activation of the block cipher.

Referring once again to FIG. 4:

For the encryption side, in every activation of the block cipher encryption function, the plaintext block is processed through the function e before being input into the block cipher encryption function. The function e uses the masking value as the key, the masking value being the result of inputting the plaintext from the previous activation of the block cipher into a checksum module, and then an xTend module which extends the result of the CS module (the checksum) into a value of the original block length. In the case of the first activation of the block cipher, an initialization vector IV is used as the masking value.

For the decryption side, in every activation of the block cipher decryption function, the ciphertext block is decrypted in the block cipher and then is processed through the function e⁻¹ (the inverse of e). The function e uses the masking value as the key, the masking value being the result of inputting the plaintext resulting from decrypting the ciphertext from the previous activation of the block cipher decryption function into a checksum module. The result of the checksum module is then input into the xTend module which extends the result of the CS module (the checksum) into a value of the original block length. In the case of the first activation of the block cipher, an initialization vector IV is used as the masking value. Those skilled in the art will appreciate that for the embodiments of e discussed above, e⁻¹, the inverse of e, is trivially derived.

Referring once again to FIG. 5:

For the encryption side, in every activation of the block cipher encryption function, the plaintext block is processed through the function e. The function e uses the masking value as the key, the masking value being the output of the block cipher encryption function. Instead of encrypting the plaintext block, the block cipher encryption function encrypts an initialization vector IV. In each activation of the block cipher, the initialization vector IV is incremented.

For the decryption side, in every block decryption operation, the block cipher encryption function encrypts an initialization vector IV. In each activation of the block cipher, the initialization vector IV is incremented. The ciphertext is processed through the function e⁻¹ (the inverse of e), with the function e using the masking value as the key, the masking value being the output of the block function encryption function. Those skilled in the art will appreciate that for the embodiments of e discussed above, e⁻¹, the inverse of e, is trivially derived.

Those skilled in the art will appreciate that the function e can be implemented in other manners than those described here. For example and without limiting the generality of the foregoing, (not depicted):

For the encryption side, in every activation of the block cipher encryption function, the plaintext block is processed through the function e before being input into the block cipher encryption function. The function e uses the masking value as the key, the masking value being the output of the function e from the previous activation of the block cipher. In the case of the first block, the function e can operate on the initialization vector IV as though it were both the plaintext block and the masking value. The plaintext is xor-ed with the masking value prior to being input into the block cipher encryption function.

For the decryption side, in every activation of the block cipher decryption function, the ciphertext block is decrypted in the block cipher and then is xor-ed with the masking value. The result of the xor-ing is output as the plaintext. The plaintext block is processed through the function e, using the masking value as the key, where the input masking value comprises the output of the function e from the previous activation of the block cipher. In the case of the first block, the function e can operate on the initialization vector IV as though it were both the plaintext block and the masking value.

Those skilled in the art will appreciate that other modes of operation which utilize the function e may be implemented as well.

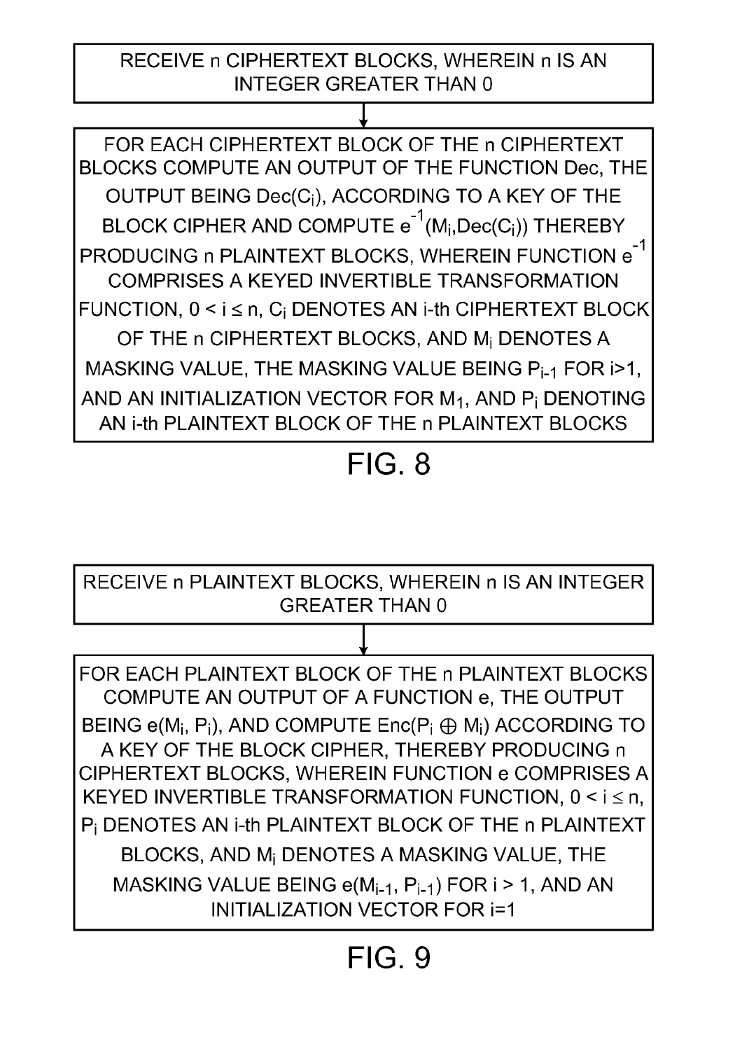

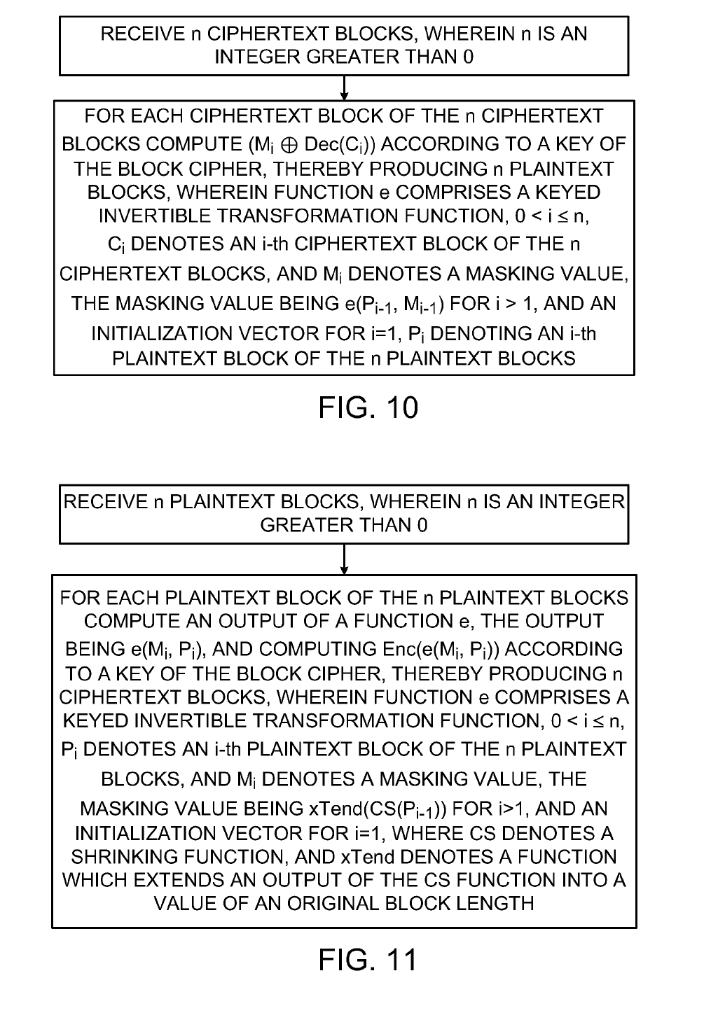

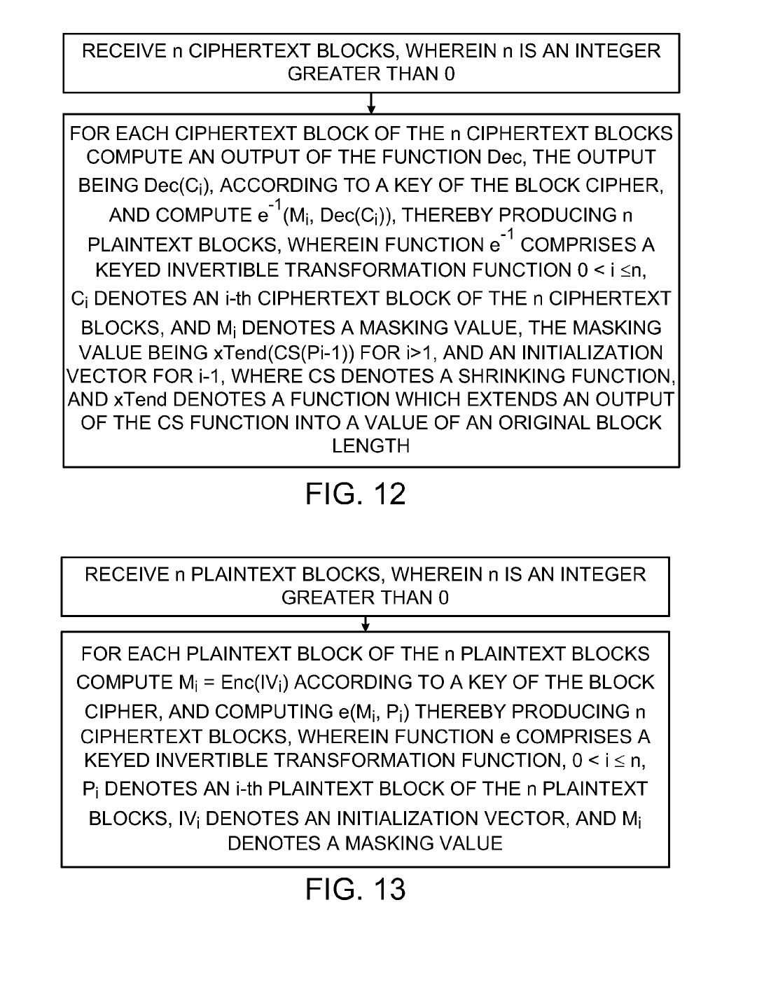

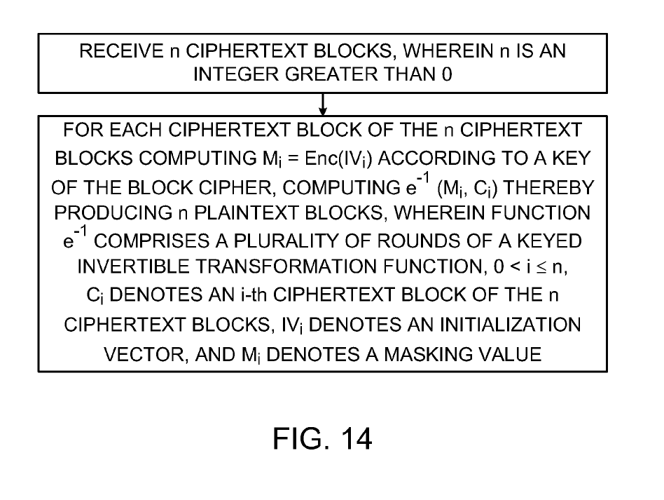

Reference is now made to FIGS. 7-14, which are simplified flowchart diagrams of preferred methods of operation of the systems described in FIGS. 2-5. The systems and methods of FIGS. 7-14 are believed to be self explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1-80. (canceled)

81. A block cipher encryption method comprising:
receiving an input of n plaintext blocks, wherein n is an integer greater than 0;
performing one of the following:
(a) inputting one of: a previous plain text or an input vector; and a current plain text into a mini-encryption function, denoted as e, the output of e being input into an encryption function;
(b) inputting one of: an input vector; and a history of all previous plain texts into a mini-encryption function, denoted as e, the output of e being and the current plain text being input into a XOR function, the output of the XOR function being input into an encryption function; and
(c) replacing the block cipher encryption mode of operation XOR function with a mini-encryption function, denoted as e, the output of the XOR function being input into an encryption function;
outputting an encrypted message from the block cipher.

82. The method according to claim 81 and further comprising, for a plaintext block cipher (PBC) mode of encryption:
for each plaintext block of the n plaintext blocks:
computing an output of a function e, the output being e(Mᵢ, Pᵢ); and
computing Enc(e(Mᵢ, Pᵢ)) according to a key of the block cipher,
thereby producing n ciphertext blocks,
wherein:
function e comprises a keyed invertible transformation function;
0<i<=n;
Pᵢ denotes an i-th plaintext block of the n plaintext blocks; and
Mᵢ denotes a masking value, the masking value being Pᵢ₋₁ for i>1, and an initialization vector for i=1.

83. The method according to claim 81 and further comprising, for a counter (CTR) mode of encryption:
for each plaintext block of the n plaintext blocks:
computing Mᵢ=Enc(IVᵢ) according to a key of the block cipher; and
computing e(Mᵢ, Pᵢ),
thereby producing n ciphertext blocks,
wherein:
function e comprises a keyed invertible transformation function;
0<i<=n;
Pᵢ denotes an i-th plaintext block of the n plaintext blocks;
IVᵢ denotes an initialization vector; and
Mᵢ denotes a masking value.

84. The method according to claim 81 and further comprising, for a plaintext block cipher (PBC) mode of encryption:
for each plaintext block of the n plaintext blocks:
computing an output of a function e, the output being e(Mᵢ, Pᵢ); and
computing Enc(Mᵢ⊕Pᵢ) according to a key of the block cipher,
thereby producing n ciphertext blocks,
wherein:
function e comprises a keyed invertible transformation function;
0<I<=n;
Pᵢ denotes an i-th plaintext block of the n plaintext blocks; and
Mᵢ denotes a masking value, the masking value being e(Mᵢ₋₁, Pᵢ₋₁) for I>1, and an initialization vector for i=1.

85. The method according to claim 81 wherein function e comprises a plurality of rounds of a second block cipher encryption or decryption function.

86. The method according to claim 85 wherein function e comprises 3 rounds of the second block cipher encryption function.

87. The method according to claim 86 wherein a round key generation algorithm of function e comprises one of:
the round key generation algorithm of the second block cipher encryption function; and
an non-standard derivation algorithm.

88. The method according to claim 87 wherein the non-standard derivation algorithm comprises xor-ing a key with round constants.

89. The method according to claim 85 wherein the round function of function e comprises one of:
the round key generation algorithm of the second block cipher encryption function; and
a tweaked block cipher round function.

90. The method according to claim 89 wherein the tweaked block cipher round function comprises any of:
pseudo-random tables;
pseudo-random s-boxes; and
pseudo-random p-boxes.

91. The method according to claim 82 wherein, prior to performing the step of computing Enc(e(Mᵢ, Pᵢ)) according to a key of the block cipher, the masking value is input first into a shrinking function, CS, the result of which is input into an extending function, xTend, which extends an output of the CS function into a value of an original block length, such that Mᵢ=xTend(CS(Pᵢ₋₁)) for i>1, and, where i=1, inputting an initialization vector.

92. The method according to claim 91 wherein the shrinking function comprises a checksum function.

93. The method according to claim 91 wherein the shrinking function outputs an output of 1-3 bytes long.

94. The method according to claim 91 wherein the xTend function extends the output of the CS function with a fixed vector.

95. The method according to claim 91 wherein the xTend function extends the output of the CS function by repeating the output of the CS function in order to extend the output to a fixed length.

96. The method according to claim 91 wherein the xTend function comprises a lookup table, and the output of the CS function comprises an index of the lookup table.

97. The method according to claim 83 wherein IVᵢ=IV+i−1.

98. A block cipher decryption method comprising:
receiving the encrypted output produced according to the method of claim 81, and decrypting it with an appropriate inverse function of the function used for encryption.

99. Block cipher encryption apparatus comprising:
a receiving unit for receiving n plaintext blocks, wherein n is an integer greater than 0;
an encryptor which performs one of the following:
(a) receives, as an input into a mini-encryption function, denoted as e, one of: a previous plain text or an input vector; and a current plain text, the output of e being input into an encryption function;
(b) receives, as an input into a mini-encryption function, denoted as e, one of: an input vector; and a history of all previous plain texts the output of e being and the current plain text being input into a XOR function, the output of the XOR function being input into an encryption function; and
(c) receives, as an input into a mini-encryption function, denoted as e, where e replaces the block cipher encryption mode of operation XOR function, the output of the XOR function being input into an encryption function;
an outputter which outputs an encrypted message from the block cipher.

100. Block cipher decryption apparatus comprising:
a receiver which receives the encrypted output produced by the apparatus of claim 99, and decrypts it with an appropriate decryptor which comprises an inverse function of the function used for encryption.
